(19) United States
(12) Patent Application Publication
(10) Pub. No.: US 2004/0033711 A1
(43) Pub. Date: Feb. 19, 2004

(54) Ergonomic connector assembly for high frequency signal transmission apparatus

(75) Inventors: Richard Whitcomb Loveless, Burlington, VT (US); Thomas Peter Dix, Winooski, VT (US)

Correspondence Address: BURR & BROWN, PO BOX 7068, SYRACUSE, NY, 13261-7068, US

(73) Assignee: Huber & Suhner, Inc., Essex Junction, VT (US)

(21) Appl. No.: 10/384,193

(22) Filed: Mar. 7, 2003

Related U.S. Application Data
(60) Provisional application No. 60/403,009, filed on Aug. 13, 2002.
(60) Provisional application No. 60/418,649, filed on Oct. 15, 2002.

(51) Int. Cl. H01R 13/213

(52) U.S. Cl. 439/314

(57) ABSTRACT

A connector assembly is provided, including a first connector body, and a rotating coupler rotatably secured to the first connector body having at least two securing members. A second connector body is also included, having at least two partially helical securing grooves formed about circumferential portions of an outer surface of the second connector body. Each of the helical securing grooves has an entry end and a terminal end. Upon assembly, the securing members enter an entry end of a respective securing groove and engage an upper axial surface thereof as the rotating coupler is rotated, and each securing member travels along the upper axial surfaces of the securing grooves toward the terminal ends thereof to securely couple the first and the second connector bodies to one another.

### CROSS REFERENCE TO RELATED APPLICATIONS

This application claims the benefit of U.S. Provisional Applications Serial No. 60/403,009 filed Aug. 13, 2002 and 60/418,649 filed Oct. 15, 2002, the entireties of which are incorporated herein by reference.

### BACKGROUND OF THE INVENTION

The present invention relates generally to cable connectors and specifically to connector assemblies for connecting radio frequency (RF) transmission cable to other RF cable or to an electronic component, such as in radio base stations, test and measurement equipment, avionics, cable television systems (CATV), and communication networks.

The use of RF signals to transfer data among various electronic components has grown in necessity as the complexity of such electronic components has increased. In turn, very sophisticated data transmission techniques that operate at very high frequencies are proliferating. In order to ensure that the high frequency signals are delivered from one piece of equipment to another (e.g., from a probing test head for semiconductor chip applications to a sophisticated piece of analysis equipment), it is common to use coaxial cable capable of carrying signals exceeding 40 GHz.

High frequency RF signals in the form of short wavelength electromagnetic waves are transmitted via the dielectric insulator portion of the coaxial cable, and the transmission behavior of the signal is related to the properties of the dielectric and the integrity of the boundary created by the center conductor and the outer shielding conductor. RF signal transmission loss can occur at points of directional changes along the cable, points of change in the dielectric material, or at steps, grooves or shoulder sections present in the structure of connector components in the RF transmission channel. In that manner, it is important to control the dimensions and characteristics of the dielectric material. A major source of discontinuity often occurs at portions where the RF cable is joined to another RF cable, or mounted to an apparatus such as a PCB (printed circuit board). Accordingly, it is important to provide a connector that secures the desired connection without interfering with the signal transmission performance.

Typically, three different types of coupling methods are used to provide an easily removable connection between RF cables and electronic components in various high frequency applications. These include traditional threaded connectors, snap-on type connectors, and bayonet lock connectors.

Threaded connectors, which are secured using a coupling nut, are generally mechanically robust and facilitate a good connection without significantly diminishing the transmitted signal frequency. Securing these connectors, however, requires using a tool, such as a torque wrench, and involves a significant amount of time to achieve the desired coupling. This can be particularly troublesome when the connectors are very small, and the speed and ease with which these connectors can be engaged is therefore limited. Moreover, threaded connector and coupling nut connector components are often machined as the preferred method of manufacturing and, in this case, include the costs associated with precision machining.

Snap-on connectors mechanically click together to provide a connection and enable faster and easier coupling, typically without using additional tools. The quality of the frequencies transmitted therethrough, however, is often limited by the structure and material of the snap-on coupler. For example, the structural connecting features of the snap-on connectors can introduce reflection points in the RF transmission channel and may not adequately maintain the desired impedance through the connector portion. Most snap-on connectors are easily snapped off and do not have the added security of a device that must be released prior to de-mating. Additionally, as with the threaded connector/coupler nut assembly, the cost of snap-on connectors that are machined include the costs of precision machining.

Bayonet locks, such as BNC (“Bayonet Neill Concelman”) connectors, have been widely popular as RF connectors since the late 1940s for a variety of reasons. A main factor attributing to the popularity of BNC connectors is that they are manually engageable with a twist-on locking ring and without the need for additional tools. BNC connectors offer other advantages, such as Gigahertz-range transmission frequency abilities, and mechanical benefits, such as good tactile feedback during the mating of BNC connectors to ports. That is, the locking ring twists easily and it is easy for an operator to tell when the posts are mated, as described below.

BNC connectors typically include a port portion having diametrically opposed posts protruding from the outer surface thereof. Another component includes a sleeve portion with spiral grooves formed on the inner surface thereof. When the sleeve is positioned over the port, the stationary posts fit into the grooves as the sleeve is twisted downward on the port. When the posts on the port reach a terminal point of the spiral inner grooves of the sleeve, the BNC connector is effectively locked in place to provide the cable connection. RF signals are transmitted through the dielectric material within the BNC connector and port.

Despite the popularity and benefits of BNC connectors, drawbacks remain. One problem associated with BNC connectors is that some of the coupling features are arranged within the RF transmission channel, which results in an undesirable loss of signal transmission at higher frequencies. That is, the grooves within the sleeve-in-sleeve connection between the connector and port outer conductors tend to radiate signal when transmitting frequencies exceed 4 GHz. BNC connectors also tend to generate undesirable noise under excess vibration. Although it is theoretically possible to use a BNC connector up to about 10 GHz, the mechanical stability at such frequencies is questionable. Accordingly, BNC connectors are not typically used at frequencies exceeding 4 GHz.

Another drawback is that the outer diameter of the sleeve must be sufficiently dimensioned to facilitate manual gripping and twisting to engage the lock connection. The typical diameter of a BNC connector is about ⅝″ at the torquing position. The ability to implement miniaturization of BNC connectors to meet goals for higher connector density is restricted since the overall size of the BNC connector is limited by the ergonomic requirement that the diameter of the sleeve must be large enough to allow a user to effectively grip and twist the connector to engage the connection. Although smaller versions, of the original post-WII BNC connectors exist, such as the Mini-BNC produced by Trompeter, the ergonomic considerations remain and continue to place a limit on the possible reduction of overall size. Thus, the size limitations, as well as the signal radiation problem associated with the coupling features being located within the RF transmission channel, limit the maximum operating frequency ability, and thus the applicability of BNC connectors for contemporary and future high frequency uses.

Yet another drawback is that BNC connectors require more raw material and plating than smaller connectors and are, to this extent, more expensive than smaller connectors.

Thus, it would be desirable to provide a connector assembly for RF cable applications that overcomes the drawbacks of the prior art. That is, it would be desirable to provide a small and ergonomic RF connector assembly sized to effectively transmit extremely high frequencies without significant transmission loss. It would also be desirable to provide an ergonomic RF connector assembly that can be easily manually engaged in a twist-lock manner, notwithstanding its miniature size. Further, it would be desirable to provide an ergonomic RF connector assembly that can be produced by low cost methods, such as casting, to avoid the production costs and forming limitations associated with machining techniques.

### SUMMARY OF THE INVENTION

An object of the present invention is to provide a connector assembly for RF cable applications that overcomes the drawbacks of the prior art. Accordingly, the present invention provides an ergonomic RF connector assembly sized to effectively transmit extremely high frequencies without significant transmission loss. The present invention also provides an ergonomic RF connector assembly that can be easily manually engaged, notwithstanding its miniature size. Further, the present invention provides an ergonomic RF connector assembly that can be produced by low-cost casting methods while avoiding the production costs and forming limitations associated with machining techniques.

According to one embodiment of the present invention, a connector assembly is provided, including a first connector body having a rotating coupler rotatably secured thereto. The rotating coupler has at least one securing member. The connector assembly also includes a second connector body having at least one partially helical securing groove formed about a circumferential portion of an outer surface thereof, and the partially helical securing groove has an entry end and a terminal end. The securing member of the rotating coupler enters the entry end of the securing groove and engages an upper axial surface of the securing groove as the rotating coupler is rotated, such that the securing member travels along the upper axial surface of the securing groove toward the terminal end thereof to securely couple the first and second connector bodies to one another.

According to another embodiment of the present invention, a connector assembly is provided, including a first connector body, and a rotating coupler rotatably secured to the first connector body. The rotating coupler has at least two securing members. The connector assembly also includes a second connector body having at least two partially helical securing grooves formed about circumferential portions of an outer surface thereof, and each of the helical securing grooves has an entry end and a terminal end. The securing members of the rotating coupler enter a respective one of the entry ends of the securing grooves and engage an upper axial surface of the respective securing grooves as the rotating coupler is rotated, such that each of the securing members travels along the upper axial surface of the securing grooves toward the terminal ends thereof to securely couple the first and the second connector bodies.

The connector assembly of the present invention does not experience the signal transmission loss at high frequencies associated with prior art connectors. This is due in part to the fact that the coupling features, i.e., the securing members and the partially helical securing grooves, are located completely outside the RF transmission channel. This is but one factor that contributes to the ability of the present invention to work effectively at even higher frequencies than currently possible with conventionally known bayonet-style connectors.

Preferably, the rotating coupler further includes a collar rotatably coupled to the first connector body, and the securing members each further include a coupler finger extending outwardly and downwardly from the collar. It is also preferred that the securing members are diametrically opposed. A plurality of coupler teeth are preferably provided as well, with each coupler tooth extending inwardly from a respective distal end of each of the coupler fingers in a direction substantially perpendicular thereto.

The coupler fingers provide a mechanical advantage and add torquing leverage to reduce the force required to turnably engage the rotating coupler and secure the first and second connector bodies. In order to increase the ergonomic benefits of the present invention, the coupler fingers preferably have a radial dimension sufficient to facilitate digital rotational manipulation (i.e., a sufficient gripping surface) to couple the first and the second connector bodies, and more preferably, the radial dimension of the coupler fingers is 0.3 to 0.5 times greater than a radial dimension of the first connector body. Further, the overall radial dimension (i.e., diameter) of the coupler fingers is preferably not greater than ¼ inch.

Thus, even though the coupler fingers are manually engaged, the ergonomic shape and position of the coupler fingers ensures that the size of the connector assembly can be reduced without limiting the ability to secure the connection. In fact, the connectors of the present invention can be beneficially dimensioned at less than half the size of conventional BNC connectors. This endows the connector assembly with an increased capacity to operate well at even higher transmission frequencies. For example, tests have shown that the connector of the present invention can be used at frequencies of 30 GHz or more, which is more than seven times greater than the maximum accepted operating frequency for BNC connectors, and about five to fifteen times greater than the maximum operating frequency of many other conventional RF connectors.

According to one embodiment of the present invention, the rotating coupler includes an annular collar positioned proximate the distal ends of the coupler fingers, such that the inwardly extending coupler teeth interrupt the inner circumferential surface of the annual collar. The annular collar adds strength and stability to the ergonomic rotating coupler without detracting from the ergonomic benefits thereof.

In accordance with a preferred embodiment, the first connector body preferably includes an upper retaining member and a lower retaining member for holding the collar of the rotating coupler in the desired position on the first connector body. The lower retaining member is defined by a retaining flange, extending outwardly from an outer surface of the first connector body, and the retaining flange preferably includes a plurality of clearances dimensioned to allow the coupler teeth of the rotating coupler to pass over the lower retaining member. The upper retaining member is preferably defined by a portion of a solder neck, crimp neck, or other mounting device.

It is also preferred that the upper axial surface of each partially helical groove of the second connector body is defined by a lower surface of a securing flange extending outwardly from an outer surface of the second connector body along a partially helical path. The entry end of each partially helical groove, i.e., the starting point of the securing flange, is separated from the terminal ends thereof by a radial distance defined by an angle of less than 180°, and more preferably, by an angle of less than 160°.

According to another embodiment of the present invention, a biasing member is positioned about the first connector body and interposed between an upper surface of the lower retaining member and a lower surface of the collar of the rotating coupler. The biasing member can be a spring arranged to bias the rotating coupler in a direction away from the second connector body, or a compact spring washer assembly.

According to another embodiment of the present invention, a rotational retaining member is positioned proximate the terminal end of the partially helical groove of the second connector body to prevent unwanted rearward rotation of the securing member engaged with the groove. The rotational retaining member is preferably a protrusion (e.g., a raised surface portion) extending outwardly from the outer surface of the second connector body. It is preferred that each securing member, specifically each coupler finger, has sufficient flexibility to traverse the protrusion during rotation of the rotating coupler, such that the coupler tooth of each securing member is interposed between the protrusion and the terminal end of the partially helical securing groove. It should be noted that a rotating coupler having an annular collar connecting the distal ends of the coupler fingers is not preferred for this embodiment.

According to another embodiment of the present invention, a rotational retaining member is provided in the form of an indentation (e.g., a notch) formed in an upper surface of the partially helical groove. Preferably, the indentation is sufficiently dimensioned to engage and retain the coupler teeth to prevent unwanted rearward motion of the securing members. The coupler tooth of each securing member engaged in the indentation is further held in place by the spring force from the biasing member. It should be noted that for the above embodiment, a rotating coupler having an annular collar connecting the distal ends of the coupler fingers is preferred to reinforce the cantilever strength of the coupler fingers.

The unique structure of the connector assembly of the present invention provides the particular advantage that the first connector body, the rotating coupler and the second connector body are all preferably formed by casting methods rather than machining techniques. Although precision shapes are required, the structure of the connector assembly is designed to maximize the efficiency of the casting process. That is, the unique shapes and relationships between connector elements are easily formed and achieved by casting since all of the coupling elements are provided outside the RF transmission channel as superficial features. This allows the connector assembly of the present invention to be produced at a fraction of the cost of machined RF connectors. More specifically, the present invention can be produced at up to one fifth of the cost associated with the production of high frequency RF connectors that are currently available.

According to yet another embodiment of the present invention, a connector assembly is provided, including a first connector body and a rotating coupler comprising a collar rotatably secured to the first connector body. The collar includes at least two coupler fingers extending outwardly and downwardly therefrom, and each of the coupler fingers has a coupler tooth extending inwardly from a distal end thereof in a direction substantially perpendicular thereto. A second connector body is also provided, and a securing member is provided, as well. The securing member includes an annular portion having an inner diameter sufficient to circumscribe at least a portion of the second connector body, and a plurality of partially helical spring fingers extending in a substantially spiraling direction from a terminal end thereof connected to the annular portion toward a distal end thereof. Each of the partially helical spring finger has an upper axial surface, a lower axial surface, and at least one rotational retaining member, such as a notch, formed in a portion of the lower axial surface thereof. Each coupler tooth engages the lower axial surface of the partially helical spring fingers as the rotating coupler is rotated, and travels along the lower axial surface of the partially helical spring fingers toward the terminal end thereof. The coupler teeth are captured by the rotational retaining members to securely couple the first and the second connector bodies to one another.

It is preferred that the second connector body include a plurality of shoulder portions which provide varying outer diametrical dimensions which in turn mechanically enable captive assemblies to be provided.

It is also preferred that the securing member comprises a material having spring properties sufficient to enable the securing member to behave as a tension spring. In that manner, the benefits associated with the above-described embodiments having a compression spring biasing member positioned about the first connector body can be realized without providing the biasing member, and thus, the overall length of the connector assembly can be favorably reduced. The securing member can be stamped or punch pressed from a sheet of material, including, but not limited to phosphor bronze, beryllium copper and stainless steel, and then formed by progressive die techniques. This relatively inexpensive process further simplifies the mold and casting required for the second connector body, reduces the overall length of the connector assembly as mentioned above, and maintains the above-described beneficial effects of providing the coupling features outside the RF transmission channel.

Thus, the connector assembly of the present invention can operate at frequencies greater than seven times the maximum useable frequency for conventional BNC connectors, is less than half the size and one fifth the volume of conventional BNC connectors, and the castably formed connector assembly of the present invention is five times less expensive (i.e., one fifth of the cost) to produce than machined RF connectors with similar RF performance.

### BRIEF DESCRIPTION OF THE DRAWINGS

For a better understanding of the nature and objects of the invention, reference should be made to the following detailed description of a preferred mode of practicing the invention, read in connection with the accompanying drawings, in which:

FIG. 1 is a perspective view of one embodiment of a connector assembly of the present invention;

FIG. 2A is cross-sectional view of a first RF cable, first solder neck, first connector body and rotating coupler rotatably attached to the first connector body according to the present invention;

FIG. 2B is a cross-sectional view of a second RF cable, second solder neck, and second connector body according to the present invention;

FIG. 3 is a perspective assembly view showing the assembly steps for the first connector body and the second connector body of the connector assembly shown in FIG. 1;

FIG. 4 is a perspective view showing the relationship between the coupler teeth at the distal ends of the coupler fingers on the rotating coupler and the receiving grooves of the second connector body according to the present invention;

FIG. 5 is a perspective view of another embodiment of the connector assembly of the present invention;

FIG. 6 is a perspective view of another embodiment of the connector assembly of the present invention;

FIG. 7 is a perspective view of a rotating coupler and biasing member according to another embodiment of the present invention;

FIG. 8A is an assembly view of a second connector body sub-assembly according to another embodiment of the present invention; and

FIG. 8B is a perspective view of the securing member shown in FIG. 8A.

### DETAILED DESCRIPTION OF THE INVENTION

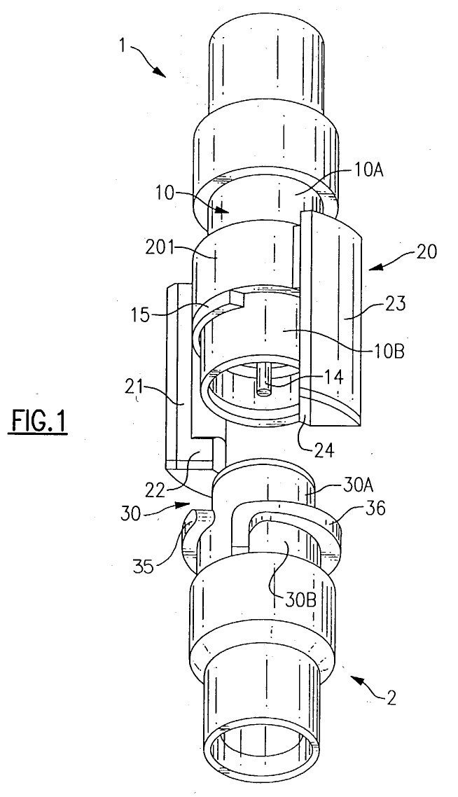

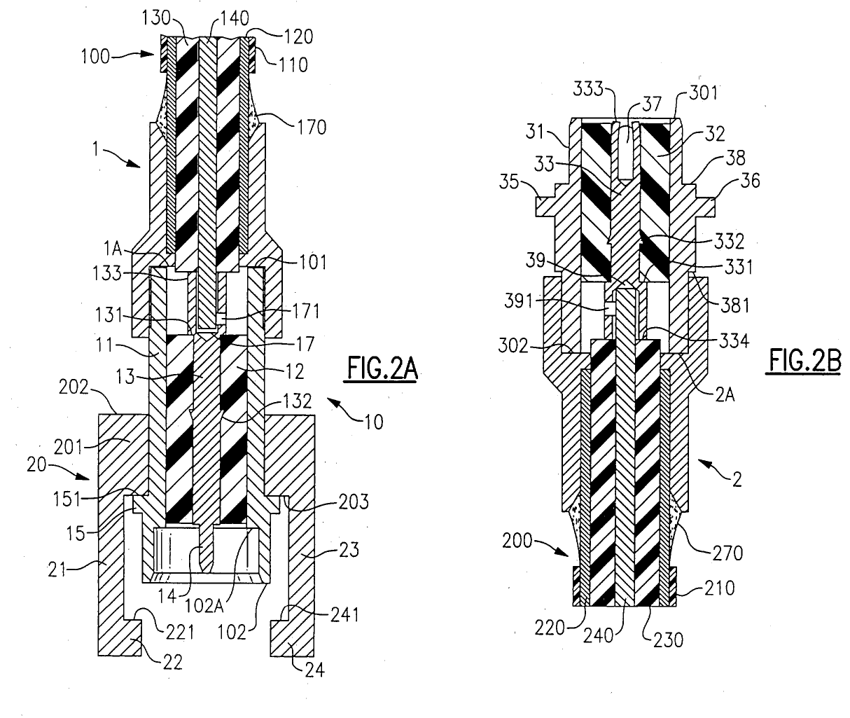

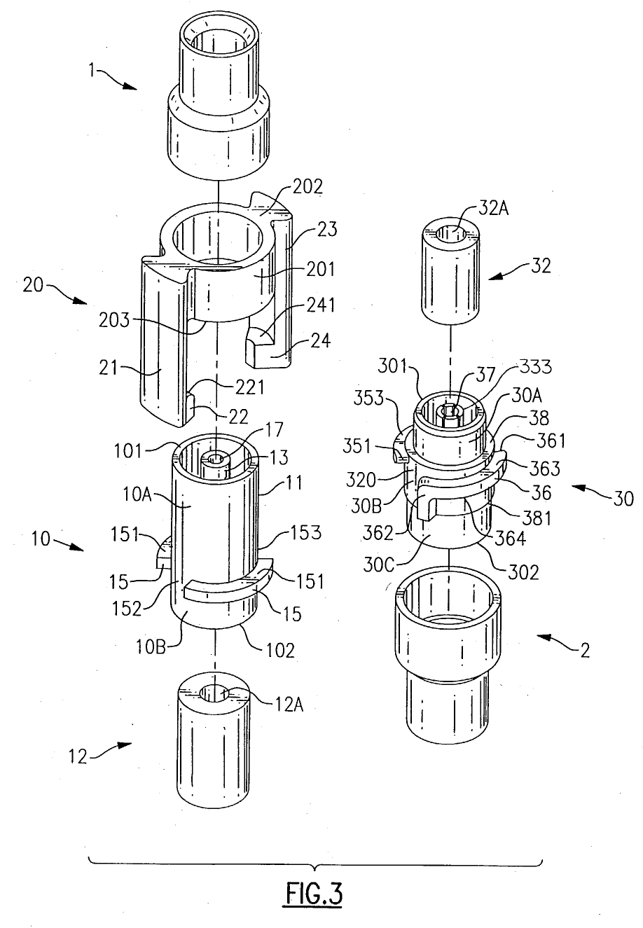

FIG. 1 is a perspective view illustrating a cable-to-cable embodiment of the connector assembly of the present invention, and FIG. 3 is a perspective assembly view of the first and second connector bodies thereof. FIGS. 1 and 3 merely depict the connector assembly and the assembly of the first and second connector bodies of the connector assembly of the present invention, however, and these figures do not show RF cables or other devices to be connected thereby. The following description is therefore best understood when read in conjunction with the cross-sectional views of FIGS. 2A and 2B, as well.

FIGS. 1 and 2A show the first connector body 10 as a substantially cylindrical member comprising a plurality of concentric cylindrical members, including a substantially cylindrical conductive outer shield 11 having an outer diameter and an inner diameter. A conductive center contact 13 is concentrically disposed within a bore 12A (see FIG. 3) formed within an insulating dielectric material 12, such that after insertion of the dielectric 12, the center contact 13 is separated from the outer shield 11 by the dielectric 12 interposed therebetween. The upper end 133 of the center contact 13 includes a recess 17 for receiving a center conductor 140 of a first RF cable 100, and the lower end of the conductive center contact 13 is formed as a conductive center pin 14 that preferably does not protrude beyond the second end 102 of the first connector body 10.

A retaining flange 15 (i.e., a lower retaining member) is formed on a portion of the outer surface of the first connector body 10. The retaining flange 15 substantially circumscribes the first connector body 10, with the exception of the points at which diametrically opposed slots 152 and 153 are formed. The retaining flange 15 effectively divides the outer surface of the first connector body 10 into a first section 10A proximate the first end 101 thereof and a second section 10B proximate the second end 102 thereof.

As best shown in FIG. 3, the rotating coupler 20 includes a substantially cylindrical hollow collar 201 having an inner diameter, a substantially planar (e.g. horizontal) upper surface 202 and a parallel, substantially planar (e.g. horizontal) lower surface 203 spaced a distance from the planar upper surface 202. It should be noted that the inner diameter of the collar 201 is preferably slightly greater than the outer diameter of the first section 10A of the first connector body 10, such that the collar 201 can be positioned, and later rotated, about a portion of the first section 10A, which is described in further detail below.

The rotating coupler 20 also includes a pair of diametrically opposed first and second coupler fingers 21 and 23, which extend outwardly and downwardly beyond the collar 201 toward their respective distal ends in a first direction which is substantially perpendicular (e.g., vertical) to the planar surfaces 202 and 203 of the collar 201. A first coupler tooth 22 extends inwardly from the distal end of the first coupler finger 21 in a direction substantially perpendicular to the first direction (e.g., horizontal), such that the top surface 221 of the first coupler tooth 22 faces the lower surface 203 of the collar 201. A second coupler tooth 24 extends inwardly from the distal end of the second coupler finger 23 in a direction substantially perpendicular to the first direction (e.g., horizontal), such that the top surface 241 of the second coupler tooth 24 faces the lower surface 203 of the collar 201.

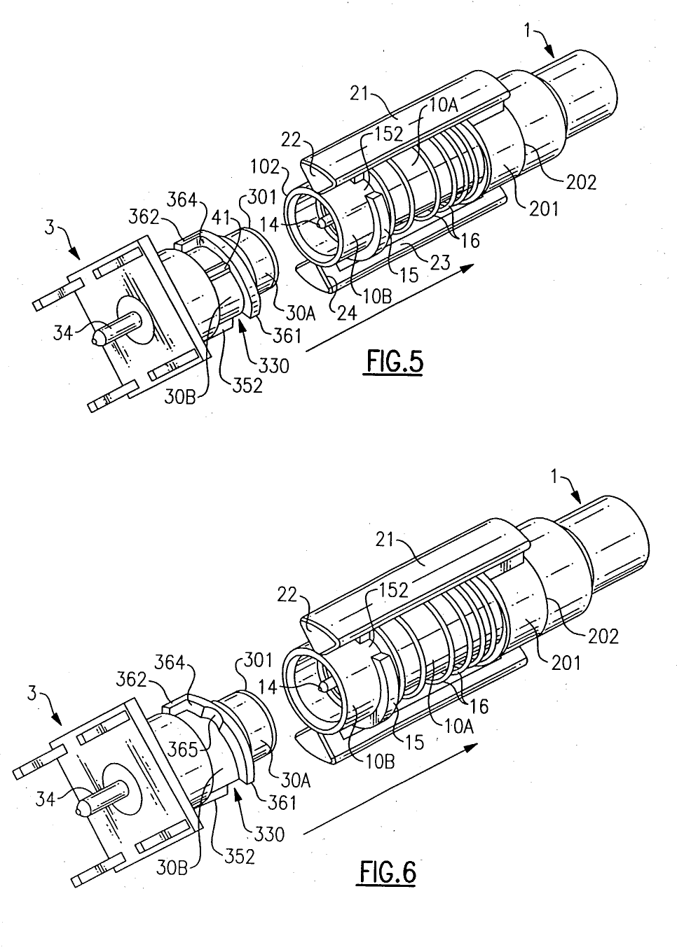

FIG. 1, in conjunction with the cross-sectional view of FIG. 2B, also shows a second connector body 30 including a substantially cylindrical conductive outer shield 31. A conductive center contact 33 is concentrically disposed in bore 32A (see FIG. 3) formed within insulating dielectric material 32, which interposes and separates the outer shield 31 and the center contact 33 after insertion thereof, as described below. The upper end 333 of the center contact 33 includes a recess 37 for receiving the center pin 14 of the first connector body 10, and the lower end of the center contact 33 is formed to include either a second recess 39 for receiving a center conductor 240 of a second RF cable 200, or a center pin 34 for connecting to other electronic components, such as a printed circuit board (PCB) (for examples, see FIGS. 5 and 6).

A first shoulder 38 is formed on a portion of the second connector body 30 and effectively divides the second connector body 30 into a first section 30A proximate the first end 301 thereof and a middle section 30B. A second shoulder 381 is formed between the second end 302 of the second connector body 30 and the middle section 30B to define a third section 30C. The middle section 30B has an outer diameter that is greater than the respective outer diameters of both the first section 30A and the third section 30C. It should be noted, however, that 30B does not necessarily have to be greater than 30C.

Moreover, the outer diameter of the first section 30A is preferably less than the outer diameter of the second section 10B of the first connector body 10 to ensure a proper nesting fit between the second end 102 of the first connector body 10 and the first end 301 of the second connector body 30. It is also important to maintain a smooth transition between the inner surfaces of the outer shield portions 11 and 31 of first and the second connector bodies 10 and 30, respectively. A closely abutted and secure fit between the first connector body 10 and the second connector body 30 is further provided by the rotating coupler 20. This fitting relationship is described in more detail below.

A first securing flange 35 is formed on a portion of the outer surface of the middle section 30B of the second connector body 30. The first securing flange 35 follows a partially helical path from a first end 351 positioned proximate the first shoulder 38 to a terminal end (not shown) positioned on nearly the opposite side of the second connector body 30 proximate the second shoulder 381. The terminal end of the first partially helical flange is bent downwardly and diverted from the partially helical path at a substantially perpendicular angle thereto. A second securing flange 36 is also formed on a portion of the outer surface of the middle section 30B of the second connector body 30. The second securing flange 36 also follows a partially helical path from a first end 361 positioned proximate the first shoulder 38 to a terminal end 362 positioned on nearly the opposite side of the second connector body 30 proximate the second shoulder 381. The terminal end 362 is bent (again, downwardly, as shown) and diverted from the partially helical path at a substantially perpendicular angle thereto.

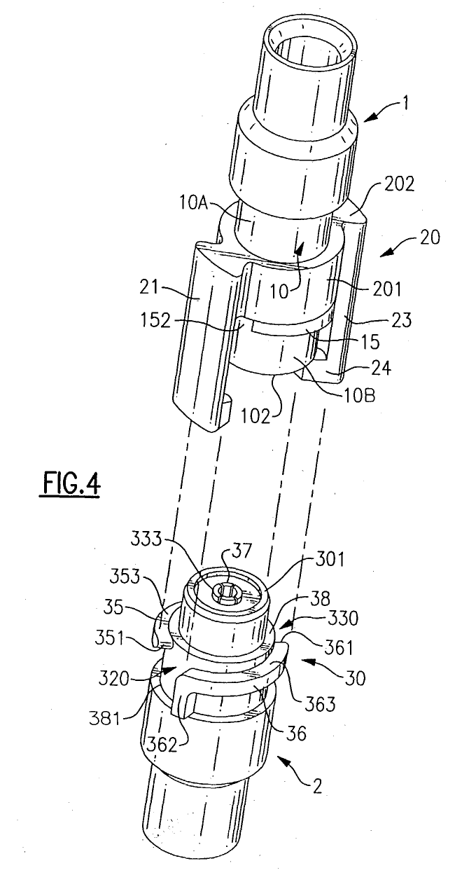

As shown in FIG. 4, the first end 351 of the first securing flange 35 is spaced a distance, vertically and horizontally, from the terminal end 362 of the second securing flange 36, such that the partially helical paths of the first and second securing flanges 35, 36 are offset and do not overlap. These spaces are hereinafter referred to as receiving spaces 320 and 330. Likewise, the second end (not shown) of the first securing flange 35 is spaced a distance from the first end 361 of the second securing flange 36. The receiving spaces 320 and 330 are located at substantially diametrically opposed positions with respect to one another on the outer surface of the middle section 30B of the second connector body 30 to best receive a respective coupler tooth 22, 24 during assembly of the first and second connector bodies 10, 30, described below.

FIG. 3, in connection with FIGS. 2A and 2B, shows how the proper, and preferred, fitting relationship of the three main parts of the connector assembly is best achieved. The first coupler tooth 22 of the rotating coupler 20 is aligned with the first slot 152 of the first connector body 10, and the second coupler tooth 24 is aligned with the second slot 153 to allow the coupler teeth 22 and 24 to pass through the retaining flange 15 and extend beyond the second end 102 of the first connector body 10. The collar 201 of the rotating coupler 20 is positioned about the first section 10A of the first connector body 10 by inserting the first section 10A of the first connector body 10 into the hollow collar 201 of the rotating coupler 20. The rotating coupler 20 is further slidably positioned until the lower surface 203 of the collar 201 is in close proximity with the upper surface 151 of the retaining flange 15. An alternative is the use of a crimp ferrule to crimp the cable outer conductor 120 onto the outer surface of a crimp neck used in place of solder neck 1 (or 2).

The protective cable jacket 110 on the coaxial RF cable 100 is stripped about 2 to 3 mm short of the top of the solder neck 1 to expose a portion of the outer conductor 120. This allows a fillet of solder 170 to form between the top and inner surfaces of the solder neck 1 and the exposed portion of the outer conductor 120 when the solder neck 1 is slipped over the exposed outer conductor 120 end portion of the cable 100 and soldered, crimped or otherwise fixed in place. That is, prior to the first solder neck 1 is press fit about the first section 10A of the first connector body 10, a portion of the cable center conductor 140 is inserted into the recess 17 formed in the otherwise solid connector center contact 13 of the first connector body 10 and is then soldered, crimped or otherwise fixed in place. FIG. 2A also shows a soldering vent 171 formed in a portion of the sidewall of the recess 17. The cable dielectric 130 (insulation) extends downward to the top end 133 of the center contact 13. The cable outer conductor 120 extends through to the solder neck 1 to the stepped portion 1A, where the inner cylindrical diameter of the solder neck 1 is reduced from a diameter sufficient to encircle the cable outer conductor 120 to a diameter only slightly larger than that of the cable dielectric 130.

The dielectric 12 of the first connector body 10 is pressed up into the first connector body 10 from the second end 102 until the top end of the connector dielectric 12 reaches a shoulder 131 formed on the connector center contact 13, which prevents further insertion. The small barb 132 formed on a substantially central portion of the connector center contact 13 catches into the dielectric 12 to prevent downward movement and to secure the position of the dielectric 12 within the first connector body 10. Although the barbed portion 132 creates minute reflection points in the RF transmission channel, it, or an alternative retaining mechanism, is mechanically necessary with respect to the proper stable positioning of the connector dielectric 12. Further, the reflection points created by the barb 132 do not significantly impact the transmission performance of the connector assembly of the present invention.

It should be noted that for cable-to-cable connections, the second solder neck 2 and the second coaxial RF cable 200 are soldered together and to the second end 302 of the second connector body 30 in much the same way as described above.

That is, as shown in FIG. 2B, The connector dielectric 32 is pressed down into the second connector body 30 from the first end 301 until the bottom end of the dielectric 32 reaches a shoulder 331 formed on the center contact 33, which prevents further insertion. The small barb 332 formed on a substantially central portion of the connector center contact 33 catches into the dielectric 32 to prevent downward movement and to secure the position of the dielectric 32 within the second connector body 30. Although the barbed portion 332 also creates minute reflection points in the RF transmission channel, it, or an alternative retaining mechanism, is mechanically necessary with respect to the proper stable positioning of the insulator 32 within the second connector body 30. Again, the reflection points created by the barb 332 do not significantly impact the transmission performance of the connector assembly of the present invention.

The protective cable jacket 210 on the RF cable 200 is stripped about 2 to 3 mm short of the bottom of the solder neck 2 to expose the cable outer conductor 220. This allows a fillet of solder 270 to form between the bottom and inner surfaces of the solder neck 2 and the exposed portion of the cable outer conductor 220 when the solder neck 2 is slipped over the exposed cable outer conductor 220 and soldered, crimped, or otherwise in place. It should be noted, however, that solder neck 2 may also be formed as an integral portion of the second connector body 30.

Prior to the second solder neck 2 being press fit onto the third section 30C of the second connector body 30, a portion of the cable center conductor 240 is inserted into the recess 39 formed in the connector center contact 33 and soldered, crimped or otherwise fixed in place.

FIG. 2B also shows a soldering vent 391 formed in a portion of the sidewall of recess 39. As shown, the cable dielectric 230 extends upward to the bottom end 334 of the connector center contact 33. The outer conductor 220 of the coaxial cable 200 extends through the solder neck 2 to the stepped portion 2A, where the inner cylindrical diameter of the solder neck 2 is reduced from a diameter sufficient to encircle the cable outer conductor 220 to a diameter only slightly larger than that of the cable dielectric 230. The mechanical coupling of the first and second connector bodies 10, 30 can then be achieved using the rotating coupler 20.

As shown in FIG. 4, the coupler teeth 22, 24 of the rotating coupler 20 are aligned with the diametrically opposed receiving spaces 320, 330 located between the first and second securing flanges 35 and 36 on the outer surface of the second connector body 30. The first end 301 of the second connector body 30 is inserted into the second end 102 of the first connector body 10, such that the stepped portion 102A of the first connector body 10 is positioned flush with respect to the upper end 301 of the second connector body 30. The conductive center contacts 13 and 33 are substantially coaxial and the conductive pin 14 of the first connector body 10 is positioned within the first recess, e.g., spring socket 37, of the second connector body 30. The respective top surfaces 221, 241 of the coupler teeth 22 and 24 are thus positioned to be substantially flush with the respective lower surfaces 354 and 364 of the first and second securing flanges 35 and 36, and then the rotating coupler 20 is rotated to securely couple the first and second connector bodies 10 and 30.

Only a minimal amount of torque is required to turn the rotating coupler 20. This rotational force is easily provided manually, without the aid of a tool, such as a wrench due to the wing-like configuration and the mechanical advantage afforded by the coupler fingers 21, 23. That is, even though the connector assembly of the present invention is less than half the size of conventional, manually engaged bayonet connector locks, the shape and position of the wing-like coupler fingers 21, 23 provide a gripping surface that is conducive to effective digital manipulation. Moreover, the coupler fingers 21, 23 only need to be rotated about a quarter of a turn in order to effectively couple the first and second connector bodies 10 and 30. Over-rotation is prevented by the 90° bend in the terminal ends 352, 362 of the securing flanges 35, 36 discussed below.

As the rotating coupler 20 is rotated, the coupler teeth 22 and 24 move downwardly away from the receiving spaces 320, 330 near the shoulder 38 along the lower surface 354, 364 of a respective one of the securing flanges 35, 36 following the partially helical path. When the coupler teeth 22, 24 reach the respective terminal ends (352 on opposite side, not shown) 362 of the securing flanges 35 and 36, further downward travel of the coupler teeth 22, 24 toward the second shoulder 381 is prevented by the 90° bend at the terminal ends 362 of the flanges 35, 36.

The (vertical component of) the distance (that the coupler teeth must travel along the lower surface of the semi-helical path of the securing flanges) between the respective first ends 351, 361 and terminal ends 352, 362 of the securing flanges 35, 36 must be greater than the total amount of play in the solder neck-first connector body-rotating coupler portion of the connector assembly. In view of the importance of controlling the impedance throughout the connector assembly, it is important that the rotating coupler enables and secures sufficient contact between the upper end 301 of the second connector body 30 and the stepped portion 102A (FIG. 2A) of the first connector body 10, where the inner diameter of the second section 10B is reduced to a dimension only slightly larger than that of the connector dielectric 12. According to the above embodiment, the coupler teeth 22, 24 of the rotating coupler 20 are held in their final position by virtue of the self-holding taper associated with the partially helical securing flanges 35, 36.

According to the embodiments shown in FIGS. 5 and 6, a biasing member (i.e., a spring) 16 can also be positioned on the first section 10A of the first connector body 10 before the rotating coupler 20 is positioned. The biasing member 16 is biased toward the first solder neck 1 (in the direction indicated by the arrow shown in FIGS. 5 and 6), that is, in an opposite direction away from the second end 102 of the first connector body 10. When the collar 201 of the rotating coupler 20 is positioned about the first section 10A of the first connector body 10, the biasing member 16 is compressed against the upper surface 151 of the retaining flange 15 as it is pushed downwardly toward the second section 10B of the first connector 10.

Interposing a biasing member 16 between the retaining flange 15 and the lower surface 203 of the collar 201 in this manner prevents the lower surface 203 of the collar 201 of the rotating coupler 20 from assuming a flush position with respect to the upper surface 151 of the retaining flange 15, which in turn prevents the coupler fingers 21 and 23 from extending a significant distance below the second end 102 of the first connector body 10. The bias of the biasing member 16 applies an upwardly directed pressure on the rotating coupler 20. By restricting the extent to which the coupler fingers 21 and 23 extend beyond the second end 102 of the first connector body 10 in this manner, the alignment between the second end 102 of the first connector body 10 (specifically the center pin 14) and the first end 301 of the second connector body 30 (specifically the recess 37, see FIG. 2B) can be achieved without any physical interference from the coupler fingers 21 and 23.

After the second end 102 of the first connector body 10 and the first end 301 of the second connector body 30 have been properly aligned and mated as described above, only a small amount of downward force (in the direction opposite the bias of the biasing member 16) is required to overcome the spring constant of the biasing member 16, depress the rotating coupler 20 and urge the coupler teeth 22, 24 into their respective receiving spaces 320 and 330 between the first and second securing flanges 35 and 36. That is, the captive assembly creates a pre-load and positions the coupler teeth 22, 24 for entry into the respective receiving spaces 320 and 330, such that the thusly positioned rotating coupler 20 can be effectively rotated via the coupler fingers 21, 23. Once engaged, further rotation of the rotating coupler toward the upper surface 151 of the retaining flange 15 causes additional compression of biasing member 16 sufficient to transfer the desired engagement pressure on mating surfaces 102A and 301. It should be noted that a biasing member 16 could also be provided for the above-described embodiments just as well as for those specifically shown in FIGS. 5 and 6.

According to the specific embodiment shown in FIG. 5, in addition to the biasing member 16, a plurality of ridge-like protrusions (40, on the opposite side, not shown) 41 are provided on the outer surface of the second connector body 30 in the middle section 30B. The protrusions 41 are respectively interposed between the lower surfaces 352, 362 of the securing flanges 35, 36 and the third section 30C of the second connector body 30. Moreover, the protrusions 41 are positioned to intersect, or at least abut, the lower surfaces 354, 364 of the securing flanges 35, 36 at a point before the respective terminal ends 352, 362 thereof.

In this case, as the rotating coupler 20 is rotated, the coupler teeth 22, 24 travel long the lower surfaces 354, 364 of the securing flanges 35, 36 until the point of intersection with a respective protrusion 41. If torquing force is maintained on the rotating coupler 20, the coupler fingers 21, 23 will flex outwardly to allow the coupler teeth 22, 24 to traverse the respective protrusion 41 and resume travel along the partially helical path toward the respective terminal ends 352, 362. The coupler teeth 22, 24 are then effectively locked into a restricted position, interposed between the protrusions 41 and the terminal ends 352, 362 of the securing flanges 35, 36.

By providing the protrusions 41 that lock the coupler teeth 22, 24 into a restricted position in this manner, any upward bias from the spring member 16 will not cause the rotating coupler 20 to un-rotate, and the coupler teeth 22, 24 will not retrace the distance up the partially helical path toward the receiving spaces 320, 330.

In the specific embodiment shown in FIG. 6, the lower surfaces 354, 364 of the first and second securing flanges 35, 36 each include a notch, e.g., an indentation, (355, on opposite side, not shown) 365 positioned before the respective terminal ends 352, 362 thereof. In this case, as torque is applied to the rotating coupler 20, the coupler teeth 22, 24 travel downwardly along the partially helical path against the lower surfaces 354, 364 of the securing flanges 35, 36, until the coupler teeth 22, 24 encounter a respective notched portion 365. At that point, further rotation of the rotating coupler 20 in either direction is substantially restricted, because the coupler teeth 22, 24 are effectively captured in the notches 365.

Similar to the above-described embodiment incorporating the protrusions 41, the notches 365 of FIG. 6 effectively lock the coupler teeth 22, 24 into a restricted position once the coupler teeth 22, 24 are captured therein during rotation of the rotating coupler 20. In this manner, any upward bias from the bias member 16 will not cause the rotating coupler 20 to un-rotate, and the coupler teeth 22, 24 will not retrace the distance up the partially helical path toward the receiving spaces 320, 330. Additionally, the upward spring force of the biasing member 16 further holds the coupler teeth 22, 24 within the notches 365.

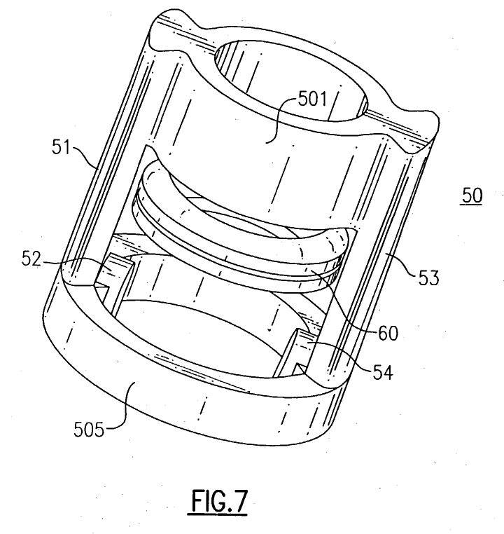

FIG. 7 is a perspective view of another embodiment of a rotating coupler 50 and biasing member 60 that can be substituted for the rotating coupler 20 and biasing member 16 shown in the connector assembly embodiment of FIG. 6. Like the above-described rotating coupler 20, the rotating coupler 50 includes a collar 501 and substantially diametrically opposed coupler fingers 51, 53 extending outwardly and downwardly therefrom. Coupler teeth 52, 54 are located at the distal ends of the coupler fingers 52, 53, respectively, and extend inwardly in a direction substantially perpendicular to the downward direction of the extending coupler fingers 51,53. In addition, an annular collar 505 connects the distal ends of the opposed coupler fingers 51, 53. In that manner, the inwardly extending coupler teeth 52, 54 interrupt the inner circumferential surface of the annular collar 505.

The inner diameter of the annular collar 505 is sufficient to traverse the outermost edges of the partially helical flanges 35, 36 located on the second connector body 30. The rounded upper surfaces 521, 541 of the coupler teeth 52, 54 still engage the receiving spaces 320, 330 and travel along the lower surfaces 354, 364 of the partially helical flanges 35, 36 until reaching the notches 355,365, as described above. The annular collar 505 lends added strength and stability to the rotating coupler 20, especially when it is under a load as a connecting partner for the overall connector assembly of the present invention. The rotating coupler 50 is not particularly suitable for the embodiment shown in FIG. 5, however. This is primarily due to the fact that the annular collar 505 limits the flexibility of the coupler fingers 21, 23. Thus, the resilience of the coupler fingers 21, 23 is eliminated, and the coupler fingers 21, 23 cannot adequately traverse the protrusions 41 to the required degree to ensure that the coupler teeth 22, 24 are properly interposed between the protrusions 41 and the terminal ends 352, 362 of the partially helical securing flanges 35, 36.

The embodiment shown in FIG. 7 includes a plurality of stacked, compact spring washers, such as Belleville washers, which comprise a biasing member 60 that can be used in place of the spring coil biasing member 16 of FIGS. 5 and 6. The first end 101 of the first connector body 10 is inserted through collar 505 into the central opening of the spring washer assembly 60, and then the collar 501 of the rotating coupler 50 is positioned about the first connector body 10. Accordingly, the inner diameter of the spring washer assembly 60 must be slightly larger than the outer diameter of at least the first portion 10A of the first connector body 10. Moreover, the outer diameter of the spring washer assembly 60 should be less than the radial distance between the inner surfaces of the coupler fingers 51, 53 of the rotating coupler 50. It should also be noted that the spring washer assembly 60 can also be positioned by sliding the assembly into place from the side before mating the first and second connector bodies 10, 30 via the rotating coupler 50.

Although a single spring washer alone may not provide the required amount of biasing movement, a back-to-back, or front-to-front stacking arrangement of a plurality of such spring washers that forms a spring washer assembly 60 (such as the stack of two shown), can be provided to overcome this limitation. The total number of stacked spring washers that can be used is somewhat restricted by the desired length of the overall connector assembly, however, which can otherwise be advantageously reduced by using spring washers instead of a coil spring. Moreover, the amount of travel in the spring washer assembly 60 must be equal to the travel for final loading and the distance between the position of the notch 355, 365 from the entry ends 351, 361 of the partially helical securing flanges 35, 36.

During the rotating connection process described above, the coupler teeth 52, 54 engage the notches 355, 365 and are securely held in place by the biasing strength of the spring washer assembly 60. Although the compact nature of the spring washer assembly 60 enables a reduction in the length (size) of the connector, the ergonomic benefits are not lost in miniaturization. That is, the ergonomic benefits associated with this embodiment of the present invention are similar to those described with respect to the other above embodiments.

As mentioned above, the third section 30C proximate the second end 302 of the second connector body 30 can be connected to a second solder neck 2 to provide a cable-to-cable connection as shown in FIGS. 1-4. Alternatively, the third section 30C of the second connector body 30 can be connected to a PCB (printed circuit board) mounting member 3, as shown in FIGS. 5 and 6. In these embodiments, the connector center contact 33 is formed to include a conductive center pin 34 extending from the second end 302 of the second connector body 30. It should also be noted, however, that the required mounting features can be integrally formed as a part of the third portion 30C.

The connector center pin 34 is positioned to extend and fully align with the connecting feature (e.g., a through-hole) of the PCB mounting member 3. The connector center pin 34 and the mounting posts of the PCB mounting member 3 also extend through corresponding through-holes provided in a printed circuit board (not shown), from the non-printed side to the printed side thereof. The connector center pin 34 is then soldered, or otherwise electrically connected, to a portion of the pattern printed on the surface of the circuit board opposite the mounting surface. In some cases, however, a separate mounting member 3 is not required, and the connector assembly is directly electrically connected to a PCB or another electronic component via the connector center pin 34.

According to yet another embodiment of the present invention, the overall length of the coupler assembly shown in FIGS. 5 and 6 can be further reduced by eliminating the biasing member 16, which is shown as a compression spring positioned about a portion of the first connector body 10.

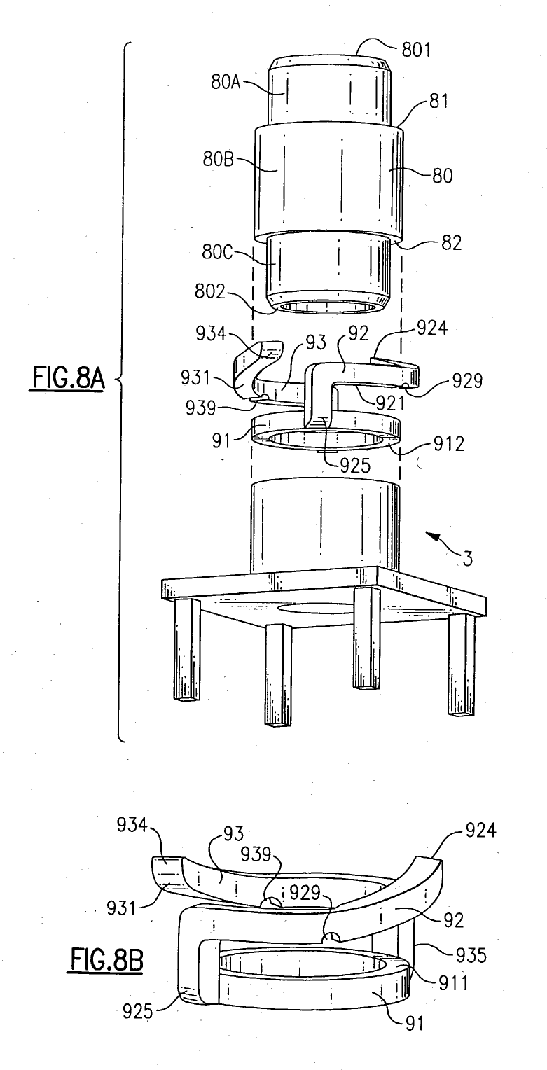

As shown in partial assembly views FIGS. 8A and 8B, the second connector body subassembly includes a second connector body 80 having a fist portion 80A defined by the first end 801 of the first connector body and a first shoulder 81, a second portion 80B defined by the first shoulder portion 81 and a second shoulder portion 82, and a third portion 80C defined by the second shoulder portion 82 and the second end 802 of the second connector body 80. As shown, the first portion 80A and the third portion 80C each have an outer diameter less than that of the second portion 80B. The previously described and integrally formed partially helical flanges are replaced by a separate securing member 90, which also functions as a tension spring.

The securing member 90 includes an annular portion 91 having an inner diameter sufficient to circumscribe the outer diameter of the second connector body 80. As shown, a pair of substantially diametrically opposed, partially helical spring fingers 92, 93 are also provided. The partially helical spring fingers 92, 93 extend away from a respective terminal end 925, 935 proximate the annular portion 91 in a spiraling direction toward respective distal ends 924, 934. Notches 929 and 939 are provided in the lower surfaces 921, 931 of the partially helical spring fingers 92, 93. As best shown in FIG. 8A, the distal end 924 of the first partially helical spring finger 92 is vertically and horizontally spaced a distance from the terminal end 935 of the second partially helical spring finger 93 by a space 94. Likewise, the distal end 934 of the second partially helical spring finger 93 is vertically and horizontally spaced a distance from the terminal end 925 of the first partially helical spring finger 92 by a space 95. Although it is not shown, the securing member 90 can also be snapped in to an annular groove, if, for example, solder neck 2 is integrally formed with 30. It should be noted, however, that these particular examples in no way limit the number of viable possibilities for the connection arrangements enabled by the present invention.

The annular portion 91 of the securing member 90 is positioned about the third portion 80C the second connector body 80, below the second shoulder portion 82. The upper surface 911 of the annular portion 91 is positioned against the surface of the shoulder portion 82 such that the securing member 90 is interposed and captured between the shoulder 82 and a PCB mounting member 3, as shown, to complete a captive sub-assembly. It should be noted, however, that it is possible to provide a similar captive sub-assembly with another component in place of the PBC mounting member 3, such as a solder neck (for cable-to-cable connections), because of the modular nature of the connector assemblies of the present invention.

The partially helical spring fingers 92, 93 extend from the annular portion 91 toward the first end 801 of the second connector body 80 to essentially form partially helical securing flanges spiraling about the second connector body 80. The partially helical spring fingers 92, 93 perform substantially the same securing function as the aforementioned partially helical flanges described with reference to FIGS. 1-6. That is, the coupler teeth 22, 24 of the rotating coupler 20 engage and travel along the lower surfaces 921, 931 of the partially helical fingers 92, 93 during the coupling of the connector assembly. The notches 929, 939 provided on the lower surface 921, 931 of the partially helical spring fingers 92, 93 capture the coupler teeth 22, 24, as described above. The leaf-spring tension of the partially helical spring fingers 92, 93 holds the coupler teeth 22, 24 securely within the notches 929, 939, helps to reduce the play in the connector assembly and securely couple the connector assembly.

While the present invention has been particularly shown and described with reference to the preferred mode as illustrated in the drawings, it will be understood by one skilled in the art that various changes in detail may be effected therein without departing from the spirit and scope of the invention as defined by the claims.

What is claimed is:

1. A connector assembly, comprising:
a first connector body;
a rotating coupler rotatably secured to said first connector body, said rotating coupler having at least two securing members; and
a second connector body having at least two partially helical securing grooves formed about circumferential portions of an outer surface of said second connector body, each of said helical securing grooves having an upper axial surface, an entry end and a terminal end;
wherein each of said securing members enters an entry end of a respective one of said securing grooves and engages said upper axial surface thereof said as said rotating coupler is rotated, such that each securing member travels along said upper axial surfaces of said securing grooves toward said terminal ends thereof to securely couple said first and said second connector bodies to one another.

2. The connector assembly of claim 1, wherein said at least two securing members are diametrically opposed.

3. The connector assembly of claim 2, wherein said rotating coupler further comprises a collar rotatably coupled to said first connector body.

4. The connector assembly of claim 3, wherein said at least two securing members each further comprise a coupler finger extending outwardly and downwardly from said collar.

5. The connector assembly of claim 4, further comprising a coupler tooth extending inwardly from a distal end of each of said coupler fingers in a direction substantially perpendicular thereto.

6. The connector assembly of claim 4, wherein said coupler fingers have a radial dimension sufficient to facilitate digital rotational manipulation to couple said first and said second connector bodies to one another.

7. The connector assembly of claim 6, wherein the diameter of said rotating coupler, measured at the outer peripheries of said coupler fingers, is 0.3 to 0.5 times greater than a radial dimension of said first connector body.

8. The connector assembly of claim 7, wherein said diameter is not greater than ¼ inch.

9. The connector assembly of claim 3, wherein said first connector body further comprises an upper retaining member and a lower retaining member for holding said collar of said rotating coupler onto said first connector body.

10. The connector assembly of claim 9, wherein said lower retaining member comprises a plurality of clearances dimensioned to allow a portion of said securing members to pass over said lower retaining member.

11. The connector assembly of claim 9, wherein said upper retaining member is defined by a portion of a member selected from the group consisting of a solder neck, a crimp neck and a mounting member.

12. The connector assembly of claim 9, wherein said lower retaining member is defined by a flange extending outwardly from an outer surface of said first connector body.

13. The connector assembly of claim 1, wherein each said partially helical groove is defined by a lower surface of a flange extending outwardly from an outer surface of said second connector body.

14. The connector assembly of claim 1, wherein said entry of each said partially helical groove is separated from said terminal end thereof by a radial distance defined by an angle of less than 180°.

15. The connector assembly of claim 14, wherein said an angle is less than 160°.

16. The connector assembly of claim 9, further comprising a biasing member positioned about said first connector body and interposed between an upper surface of said lower retaining member and a lower surface of said collar.

17. The connector assembly of claim 16, wherein said biasing member comprises a spring to bias said rotating coupler in a direction away from said second connector body.

18. The connector assembly of claim 1, further comprising a rotational retaining member positioned proximate said terminal end of each said partially helical groove to prevent unwanted rearward rotation of said securing member engaged with said groove.

19. The connector assembly of claim 18, wherein said rotational retaining member comprises a protrusion extending outwardly from an outer surface of said second connector body.

20. The connector assembly of claim 18, wherein each said securing member has a sufficient flexibility to traverse said protrusion during rotation of said rotating coupler, such that a portion of each said securing member is interposed between said protrusion and said terminal end of said partially helical securing groove.

21. The connector assembly of claim 18, wherein said rotational retaining member comprises an indentation in an upper surface of said partially helical groove.

22. The connector assembly of claim 21, wherein said indentation is sufficiently dimensioned to engage and retain a portion of each said securing member to prevent unwanted rearward motion of each said securing member.

23. A connector assembly, comprising:
a first connector body;
a rotating coupler comprising a collar rotatably secured to said first connector body, said collar having at least two coupler fingers extending outwardly and downwardly therefrom and each said coupler finger having a coupler tooth extending inwardly from a distal end thereof in a direction substantially perpendicular thereto; and
a second connector body having at least two partially helical securing grooves formed about circumferential portions of an outer surface of said second connector body, each of said helical securing grooves having an upper axial surface, an entry end and a terminal end;
wherein each said coupler tooth enters an entry end of a respective one of said securing grooves and engages said upper axial surface thereof as said rotating coupler is rotated, such that each said coupler tooth travels along said upper axial surfaces of said securing grooves toward said terminal ends thereof to securely couple said first and said second connector bodies to one another.

24. The connector assembly of claim 23, wherein said coupler fingers of said collar are diametrically opposed.

25. The connector assembly of claim 24, wherein an outermost diameter of said rotating coupler, measured at the outer peripheries of said coupler fingers, is 0.3 to 0.5 times greater than a radial dimension of said first connector body.

26. The connector assembly of claim 25, wherein said diameter is not greater than ¼ inch.

27. The connector assembly of claim 23, wherein said first connector body further comprises an upper retaining member and a lower retaining member for holding said collar of said rotating coupler onto said first connector body.

28. The connector assembly of claim 27, wherein said lower retaining member comprises a plurality of clearances dimensioned to allow a portion of said coupler fingers to pass over said lower retaining member.

29. The connector assembly of claim 27, wherein said upper retaining member is defined by a portion of a member selected form the group consisting of a solder neck, a crimp neck and a mounting member.

30. The connector assembly of claim 27, wherein said lower retaining member is defined by a flange extending outwardly from an outer surface of said first connector body.

31. The connector assembly of claim 23, wherein each said partially helical groove is defined by a lower surface of a flange extending outwardly from an outer surface of said second connector body.

32. The connector assembly of claim 23, wherein said entry of each said partially helical groove is separated from said terminal end thereof by a radial distance defined by an angle of less than 180°.

33. The connector assembly of claim 32, wherein said an angle is less than 160°.

34. The connector assembly of claim 27, further comprising a biasing member positioned about said first connector body and interposed between an upper surface of said lower retaining member and a lower surface of said collar.

35. The connector assembly of claim 34, wherein said biasing member comprises a spring to bias said rotating coupler in a direction away from said second connector body.

36. The connector assembly of claim 34, wherein said biasing member comprises at least one spring washer.

37. The connector assembly of claim 23, further comprising a rotational retaining member positioned proximate said terminal end of each said partially helical groove to prevent unwanted rearward rotation of each said coupler tooth engaged with said groove.

38. The connector assembly of claim 37, wherein said rotational retaining member comprises a protrusion extending outwardly from an outer surface of said second connector body.

39. The connector assembly of claim 38, wherein each said coupler finger has a sufficient flexibility to traverse said protrusion during rotation of said rotating coupler, such that a portion of each said coupler tooth is interposed between said protrusion and said terminal end of said partially helical securing groove.

40. The connector assembly of claim 37, wherein said rotational retaining member comprises an indentation in an upper surface of said partially helical groove.

41. The connector assembly of claim 40, wherein said indentation is sufficiently dimensioned to engage and retain a portion of each said coupler tooth to prevent unwanted rearward motion of each said coupler finger.

42. A connector assembly, comprising:
a first connector body;
a rotating coupler comprising a collar rotatably secured to said first connector body, said collar having at least two diametrically opposed coupler fingers extending outwardly and downwardly therefrom, each said coupler finger having a coupler tooth extending inwardly from a distal end thereof in a direction substantially perpendicular thereto, wherein an outermost diameter of said rotating coupler, measured at outer peripheries of said coupler fingers, is 0.3 to 0.5 times greater than a radial dimension of said first connector body; and
a second connector body having at least two partially helical securing grooves formed about circumferential portions of an outer surface of said second connector body, each of said helical securing grooves having an upper axial surface, an entry end and a terminal end;
wherein each said coupler tooth enters an entry end of a respective one of said securing grooves and engages said upper axial surface thereof said as said rotating coupler is rotated, such that each said coupler tooth travels along said upper axial surfaces of said securing grooves toward said terminal ends thereof to securely couple said first and said second connector bodies to one another.

43. The connector assembly of claim 42, wherein said diameter is not greater than ¼ inch.

44. The connector assembly of claim 42, wherein said first connector body further comprises an upper retaining member and a lower retaining member for holding said collar of said rotating coupler onto said first connector body.

45. The connector assembly of claim 44, wherein said lower retaining member comprises a plurality of clearances dimensioned to allow a portion of said coupler fingers to pass over said lower retaining member.

46. The connector assembly of claim 44, wherein said upper retaining member is defined by a portion of a member selected from the group consisting of a solder neck, a crimp neck and a mounting member.

47. The connector assembly of claim 44, wherein said lower retaining member is defined by a flange extending outwardly from an outer surface of said first connector body.

48. The connector assembly of claim 42, wherein each said partially helical groove is defined by a lower surface of a flange extending outwardly from an outer surface of said second connector body.

49. The connector assembly of claim 42, wherein said entry of each said partially helical groove is separated from said terminal end thereof by a radial distance defined by an angle of less than 180°.

50. The connector assembly of claim 49, wherein said an angle is less than 160°.

51. The connector assembly of claim 44, further comprising a biasing member positioned about said first connector body and interposed between an upper surface of said lower retaining member and a lower surface of said collar.

52. The connector assembly of claim 51, wherein said biasing member comprises a spring to bias said rotating coupler in a direction away from said second connector body.

53. The connector assembly of claim 42, further comprising a rotational retaining member positioned proximate said terminal end of each said partially helical groove to prevent unwanted rearward rotation of each said coupler tooth engaged with said groove.

54. The connector assembly of claim 53, wherein said rotational retaining member comprises a protrusion extending outwardly from an outer surface of said second connector body.

55. The connector assembly of claim 54, wherein each said coupler finger has a sufficient flexibility to traverse said protrusion during rotation of said rotating coupler, such that a portion of each said coupler tooth is interposed between said protrusion and said terminal end of said partially helical securing groove.

56. The connector assembly of claim 53, wherein said rotational retaining member comprises an indentation in an upper surface of said partially helical groove.

57. The connector assembly of claim 56, wherein said indentation is sufficiently dimensioned to engage and retain a portion of each said coupler tooth to prevent unwanted rearward motion of each said coupler finger.

58. A connector assembly, comprising:
a first connector body;
a rotating coupler comprising a collar rotatably secured to said first connector body, said collar having at least two coupler fingers extending outwardly and downwardly therefrom and each said coupler finger having a coupler tooth extending inwardly from a distal end thereof in a direction substantially perpendicular thereto;
a second connector body extending in an axial direction from a first end to an opposed second end thereof, said second connector body comprising at least a first portion having a first outer diameter and a second portion having a outer diameter; and
a securing member comprising an annular-portion having an inner diameter sufficient to circumscribe at least a portion of said second connector body, and a plurality of partially helical spring fingers, each said partially helical spring finger extending in a substantially spiraling direction from a terminal end thereof connected to said annular portion toward a distal end thereof, each said partially helical spring finger having an upper axial surface, a lower axial surface, and at least one rotational retaining member formed in a portion of said lower axial surface thereof;
wherein each said coupler tooth engages said lower axial surface of each said partially helical spring finger as said rotating coupler is rotated, such that each said coupler tooth travels along said lower axial surface of each said partially helical spring finger toward said terminal end thereof, each said coupler tooth being captured by said rotational retaining member to securely couple said first and said second connector bodies to one another.

59. The connector assembly of claim 58, wherein said second connector body further comprises a third portion having a third outer diameter.

60. The connector assembly of claim 59, wherein said first portion of said second connector body is defined by said first end of said second connector body a first shoulder portion, said second portion of said second connector body is defined by said first shoulder portion and a second shoulder portion, and said third portion or said second connector body is defined by said second shoulder portion and said second end of said second connector body

61. The connector assembly of claim 59, wherein said second outer diameter of said second connector body is greater than at least one of said first and said third outer diameters of said second connector body.

62. The connector assembly of claim 58, wherein said rotational retaining member comprises at least one notch.

63. The connector assembly of claim 62, wherein said notch is sufficiently dimensioned to engage and retain a portion of each said coupler tooth to prevent unwanted rearward motion of each said coupler finger.

64. The connector assembly of claim 58, wherein said securing member comprises a material having spring properties sufficient to enable said securing member to behave as a tension spring.

65. A connector assembly, comprising:
a first connector body including a rotating coupler rotatably secured thereto, said rotating coupler having at least one securing member; and
a second connector body having at least one partially helical securing flange formed about a circumferential portion of an outer surface of said second connector body, said partially helical securing groove having a lower axial surface, an first end and a terminal end;
wherein said securing member of said rotating coupler engages said securing flange proximate said first end thereof and engages said lower axial surface thereof as said rotating coupler is rotated, such that said securing member travels along said lower axial surface of said securing flange toward said terminal end thereof to securely couple said first and said second connector bodies to one another.

66. A connector assembly, comprising:
a first connector body including a rotating coupler rotatably secured thereto, said rotating coupler having at least one securing member; and
a second connector body having at least one partially helical securing groove formed about a circumferential portion of an outer surface of said second connector body, said partially helical securing groove having an upper axial surface, an entry end and a terminal end;
wherein said securing member of said rotating coupler enters said entry end of said securing groove and engages said upper axial surface thereof as said rotating coupler is rotated, such that said securing member travels along said upper axial surface of said securing groove toward said terminal end thereof to securely couple said first and said second connector bodies to one another.
